(19) United States
(12) Patent Application Publication
(10) Pub. No.: US 2022/0374736 A1
(43) Pub. Date: Nov. 24, 2022

(54) MACHINE LEARNING PLATFORM FOR OPTIMIZING COMMUNICATION RESOURCES FOR COMMUNICATING WITH USERS

(71) Applicant: Humana Inc., Louisville, KY (US)

(72) Inventors: Linda Nguyen Chung, Irvine, CA (US); Rajiv Kumar Gumpina, Louisville, KY (US); Dan Carroll Hawk, III, Louisville, KY (US); Peyman Yousefian, Frederick, MD (US); Sravya Etlapur, Rochester, MN (US); Yunliang Cai, Lexington, MA (US); Nataley Savanah Kennedy, Louisville, KY (US)

(21) Appl. No.: 17/326,429

(22) Filed: May 21, 2021

(51) Int. Cl. G06N 5/04; G06N 20/00

(52) U.S. Cl. CPC G06N 5/04; G06N 20/00

(57) ABSTRACT

A system according to an embodiment optimizes communications with users using machine learning based models. The system receives user profile data for a set of users. For each user from the set of users, the system provides the user profile data as input to a machine learning based model and determines attributes describing the user, for example a measure of adherence rate for the user. The system ranks the set of users based on the predicted attributes. The system selects a subset of users from the set of users based on the ranking. For each selected user from the set of selected users, the system determines communication parameters for communicating with the selected user and sends a communication to the selected user based on the determined communication parameters.

### BACKGROUND

The disclosure relates to communication mechanisms for interacting with users in general and more specifically to machine learning platform for optimizing communication resources for communicating with users.

Organizations perform interactions with users on a regular basis. Such interactions may be performed using various communication mechanisms such as SMS text, automated phone calls, live agent calls, and so on. A communication mechanism may also be referred to as a communication channel. Different communication mechanisms have different resource utilization. Accordingly, certain communication mechanisms utilize more resources than others. An organization may have to communicate with a large number of users and typically does not have sufficient resources to reach out to all users within reasonable time. Furthermore, depending on the goals that the organization wants to achieve, it may be more important for the organization to prioritize reaching out to some users over other users. Furthermore, different users respond differently to different modes of communication. Accordingly, the rate of user response depends on the communication mechanism used to interact with the users.

Organizations often use simple rule-based heuristics for determining how to communicate with users. These heuristics may use broad categorizations of users and are not personalized to specific user's conditions and behavior. Furthermore, these rule-based techniques lack quantitative measures to monitor efficiency of the communication mechanisms, thereby making the process difficult to adapt to continuously changing data. As a result, the communications performed with users do not utilize the communication resources effectively. Furthermore, use of incorrect communication mechanism to communicate with users resulting in lower rate of user response. This results in waste of communication and computational resources. Furthermore, the organization fails to reach the target goal that the organization was attempting to reach by communicating with the users.

### SUMMARY

A system according to an embodiment optimizes communications with users using machine learning based models. The system receives user profile data for a set of eligible users. For each eligible user from the set of eligible users, the system provides user profile data as input to a machine learning based model and determines an adherence rate for the eligible user. The system ranks the set of eligible users based on the predicted adherence rates. The system selects a set of users from the set of eligible users based on the ranking. For each selected user from the set of selected users, the system determines communication parameters for communicating with the selected user and sends a communication to the selected user based on the determined communication parameters.

According to an embodiment, a communication parameter indicates a communication channel selected from a plurality of communication channels used for communicating with users. Examples of communication channels include a communication channel for sending text messages, a communication channel for leaving voice mail, a communication channel for calling via live agent.

According to an embodiment, a communication parameter indicates a timing for sending a communication to the selected user. The system determines the timing for sending the communication to the selected user based on a predicted gap for the user. A gap indicates a time interval when the user is not in possession of an item, for example, medication.

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 shows the overall system environment of a system configured to communicate with users via multiple communication channels to invoke a user interaction from the users, according to an embodiment.

FIG. 2 shows the system architecture of the communication channel selection module, according to an embodiment.

FIG. 3 shows a flowchart illustrating the process for generating training data for training a machine learning based model, according to an embodiment.

FIG. 4 shows a flowchart illustrating the process for using the machine learning based model for communicating with a user, according to an embodiment.

FIG. 5 shows a flowchart illustrating the feedback process for improving the machine learning based model, according to an embodiment.

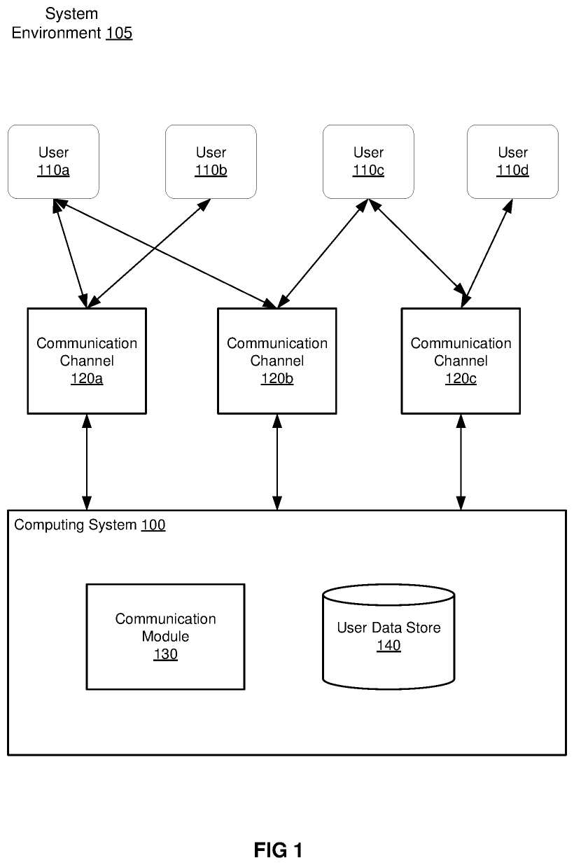

FIG. 1 and the other figures use like reference numerals to identify like elements. A letter after a reference numeral, such as “120a,” indicates that the text refers specifically to the element having that particular reference numeral. A reference numeral in the text without a following letter, such as “120,” refers to any or all of the elements in the figures bearing that reference numeral (e.g. “120” in the text refers to reference numerals “120a” and/or “120b” in the figures).

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### DETAILED DESCRIPTION

Organizations that have a user base often interact with the users to evoke a particular reaction from the user, for example, to ensure that a user performs certain expected action. There are costs associated with communicating with users. For example, communicating with a user may require an agent and there may be a limited number of agents available. Furthermore, different users may have different degrees of urgency with which the organization needs to reach them. Organizations have limited resources for communicating with users. A system according to various embodiments uses machine learning based techniques to optimize communications with users. The system aims to maximize the likelihood of the user performing the expected user action while minimizing the communication costs of reaching the users.

### Overall System Environment

FIG. 1 shows the overall system environment of a system configured to communicate with users via multiple communication channels to invoke a user interaction from the users, according to an embodiment. The overall system environment 105 includes a computing system 100 that can communicate with users 110a, 110b, 110c, 110d using a communication channel 120a, 120b, 120c. In other embodiments, more or fewer systems/components than those indicated in FIG. 1 may be used. A user may also be referred to as a member, for example, a member of a health care system. Furthermore, there may be more or less instances of each system shown in FIG. 1, for example, there may be as additional communication channels 120.

The computing system 100 includes a communication module 130 and a user data store 140. Other embodiments of the computing system 100 may include more or fewer modules. The computing system 100 may be used by an organization that has a user base, for example, a health care system that has members, a business that has customers, or any organization that has members that subscribe to the services of the organization, for example, an educational organization, a library, and so on.

The user data store 140 stores attributes of users. The user data store 140 may store demographic data describing the user including age, gender, and so on. The user data may store other attributes of a user, for example, member behavior preference, activity preference, or billing preferences. The attributes represent features of the specific domain for which the computing system 100 is used. For example, if the computing system is used for managing health care information for users, the user data store 140 stores health care profiles for the users including any relevant medical conditions of the user.

Certain attributes of the user profile are indicative of an urgency by which the organization needs to communicate with the user. For example, if the computing system is used by an organization managing health care information for users, an attribute of a user represents medical condition of the user, for example, hyperlipidemia, hypertension, diabetes, or other condition. The medical condition is associated with a measure of urgency or a measure of significance of communicating with the user within a threshold time interval. For example, the user may have immediate health risk if the user is not reached for picking up medication that is prepared for the user and is ready for pickup.

An attribute of the user stored in the user profile is the medical adherence level of the user that represents degree to which a patient correctly follows medical advice and takes medication prescribed and prepared for the user. In an embodiment, the medical adherence of the user is indicated by a measure called percentage days covered (PDC). The PDC measure may represent a percentage of days (or the fraction of number of days) within a time interval during which the user satisfies certain criteria. The criteria may be satisfied if the user has an attribute that has value in specified range, for example, the attribute may indicate that the user is in possession of an item such as a product or a service. For health care domain, the item may be a medication that the user was prescribed, and the PDC measure indicates the percentage of days in a time interval when the user was determined to be in possession of a medication that was prescribed for the user.

The PDC may be measured as a ratio of the number of days that the user was covered (i.e., the user was determined to be in in possession of medication) and the number or days that the user was eligible to take medication (i.e., including the days that the medication was prepared and available at a pharmacy that the user was eligible to pick up but may not have picked up). If the user is out of supply of the medication and the user has not picked up new medication supply from the pharmacy, the system determines that the user is not in possession of the medication during this period and as a result, there is a gap in the user's medication. These are referred to as gap days. The user profile may store information describing the gap days of the user. If the computing system is used for reaching customers of a business, the user data store 140 may store the type of products/services that the customer has received in the past as well as interests of the user.

The computing system according to an embodiment, performs: (1) identification and prioritization of users who need outreach to improve their medical adherence, (2) recommends a type of communication with the user that is determined to be optimal in terms or resources as well as the likelihood of reaching the user or causing the user to take the requested action, and (3) recommends a time of performing the communication such that the likelihood of the user performing the expected user action is maximized as a result of sending the communication at the recommended time, thereby improving the user's medical adherence level.

The computing system receives user profile data, for example, user's healthcare profile data, users historical refill, and outreach data. The system performs a series of machine learning computations to determine an output comprising: (1) a list of members with identified PDC levels with whom the system needs to communicate within a threshold time interval, and (2) the type of communication channels to user to communicate with the identified users and (3) the time when the system should communicate, for example, the dates when the system should reach out to the identified users.

Examples of communication channels 120 include messaging platforms such as SMS text, automated phone calls, live agent calls, using a third-party system to reach a user, and so on. The communication module 130 includes instructions for communicating with a user using any of the communication channels.

The users perform certain user actions in response to the communication received by the user via a communication channel. These are target user actions that the organization maintaining the computing system 100 expects the users to perform. For example, if the organization if a pharmacy that performs outreach to patients to pick up medication, the expected user action is the user picking up the medication. If the organization is a business enterprise, the expected user action may be, the user purchasing an item or performing an interaction associated with an item, for example, requesting additional material describing the item, registering with a website associated with the organization, recommending the item to another user, filling out a survey related to the item, and so on.

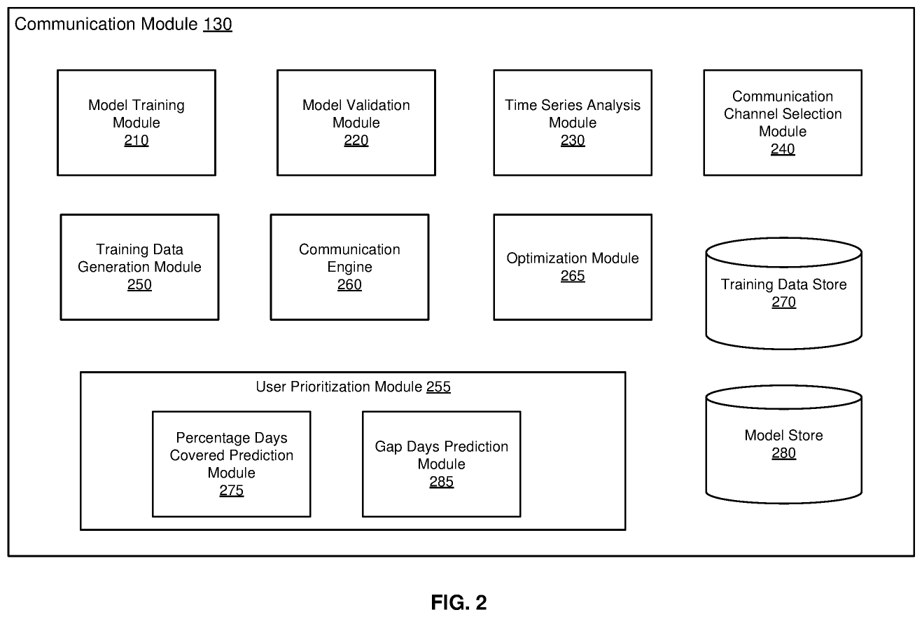

The communication module 130 uses machine learning techniques to determine the optimal communication channel to use for communicating with a user so as to maximize the likelihood that the user will perform an expected user action. Further details of the communication module 130 are described herein, for example, in connection with FIG. 2.

Typically, the computing system 100 performs repeated communications with each user over time and also monitors the user actions over time. As a result, the computing system stores a time series representing the communications performed with each user and also one or more time series representing the user actions as they occur. The information is stored as a time series since each data point representing either a communication or a user action is associated with a timestamp value. Accordingly, the time series data may be stored as pairs (t, v) where t is a timestamp value and v is a data value. The time series information may be stored in the user data store 140 or in a separate time series data store that is linked to the user data store 140.

The user data store 140 includes time series data associated with the user. The time series data associated with the user includes (1) communication time series data and (2) event time series data. The communication time series data includes instances of communications performed by the organization or the system with the user. The communication module 130 may perform communications with a user using any of the communication channel. The user data store 140 stores a time series representing the communications performed with the users and the corresponding timestamps at which the communication was performed. A communication may represent an intervention performed for a user to inform the user about medication that the user needs to pick up from a pharmacy. The communication time series may be represented as a binary time series. Accordingly, the communication time series is represented using binary values, i.e., the value for a date (or a timestamp) is one if a communication was sent to the user on that day or else the communication time series value is zero.

The event time series data represents events associated with the user. Event time series is also referred to as behavior time series, since the user behavior determines the events associated with the user. In an embodiment, the events represent health care events associated with the user. As an example, an event may indicate that the user picked up medication from a pharmacy. The event time series represents timestamps associated with events associated with the user. The timestamp may be represented as a data, for example, the date when a user picks up the medication from a pharmacy. In an embodiment, the event time series is represented using binary data, for example, a value of 1 for a date indicates that the user had mediation and a value of 0 indicates that the user does not have medication. Accordingly, the event time series represents values of an attribute describing the user, the attribute associated with an event. If the attribute value is greater than a threshold, the event time series has a value V1 for a timestamp (or date) and the event time series has a value V2 otherwise. If the user attribute has binary values, the event time series may use the binary values of the user attribute at each time point.

The user data store may represent event duration using a binary time series. For example, the event time series data may represent the last day for an event to finish, for example, the last day on hand (LDOH) event indicating that the user would run out of medication on that day unless the user picks up medication. Accordingly, the event time series value for a day has value one if the day represents an LDOH event and a value zero otherwise.

### System Architecture

FIG. 2 shows the system architecture of the communication module 130, according to an embodiment. The communication module 130 includes a model training module 210, a model validation module 220, a time series correlation module 230, a communication channel selection module 240, a training data generation module 250, a user prioritization module 255, a communication engine 260, an optimization module 265, a training data store 270, and a model store 280. Other embodiments may include other modules. Actions indicated as being performed by a particular module may be performed by other modules than those indicated herein.

The training data generation module 250 generates training data for training the machine learning based models and stores the training data in the training data store 270. The model training module 210 trains machine learning based models used for determining the optimal communication channel to communicating with a user. The training data generation module 250 invokes the time series analysis module 230 to analyze time series data representing past instances of communication by the computing system 100 with a user and user interaction data from that user. The time series analysis module 230 analyzes time series data to generate labels for user indicating the likelihood of a user performing the expected user action in response to use of a particular communication channel to communicate with the user.

A model trained by the model training module 210 is validated by the model validation module 220. A model that is successfully validated is used by the communication module 240. A machine learning based model that fails validation may be retrained using additional training data and the process repeated until the model passes validation.

The machine learning based models are stored in the model store 280. A model comprises a set of parameters that are stored in the model store 280. The parameters of a model are adjusted using the training data during the training phase of the model. A model is associated with a set of instructions used for executing the model. The parameters of the model are processed using instructions for the model by the communication channel selection module 240. The various models trained and executed by the system that may be stored in the model store 280 include: (1) a machine learning based model (referred to as PDC model) that is configured to receive user data including the health care profile of the user and the time series data for the user to predict percentage days covered for the user; (2) a machine learning based model (referred to as gap days model) that predicts an event for a user, for example, an event representing a gap for the user when the user is without medication (this model may be used to determine the timing for sending a communication to the user, for example, an intervention requesting the user to pick up medication that may have been prepared for the user); and (3) a machine learning based model (referred to as communication channel model) that predicts the optimal communication channel to user for communicating with the user such that minimal resources of the system are utilized and the chances of improving the adherence of the user are maximized.

The communication channel selection module 240 identifies and prioritizes the type and time of communication to be performed for a user, for example, for performing intervention. The communication channel selection module 240 determines the communication channel or the communication mechanism to be used for the user, for example, by executing the communication channel model. The communication channel selection module 240 selects a communication channel that is personalized at a user level for communicating with the user. The communication channel selection module 240 further recommends the optimal time for communicating with the user such that the user is most likely to respond to the communication, thereby resulting in a successful intervention with the user to close a potential gap in medication. The communication channel selection module 240 may determine the timing for sending a communication using the gap days model to identify a potential gap that is likely to happen in the near future for a user. The communication channel selection module 240 recommends sending a communication within a threshold time interval of the potential gap to maximize the likelihood of the user picking up the medication in response to the communication.

The training data used for training the machine learning based models includes samples based on various users that have user interaction data available. The training data includes, for each user, a feature vector describing user profile attributes of the user and labels indicating the communication channels that are determined to be optimal for each user.

The time series analysis module 230 analyses the time series associated with the users to determine attributes describing the users for use as features extracted from the user data for inputting to the machine learning based models according to various embodiments. The time series analysis module 230 determines a measure of correlation between a communication time series and an event time series for a user. The communication module 130 uses the measure of correlation between a communication time series and an event time series for the user as a measure of the degree to which the user responds to communications performed using a particular communication channel. In an embodiment, the time correlation analysis performed is a causality analysis providing a measure of a degree to which the event time series is determined to be caused by the communication time series. The use of causality analysis allows the system to convert large amount of time series data into a simple value (e.g., a scalar value) that represents an attribute of the user. This simplifies the processing of the machine learning based models since it is easier to process a scalar attribute of a user compared to a large number of values of a time series data.

In an embodiment, the causality analysis is the Granger causality analysis. According to the Granger causality analysis, a variable X that evolves over time is determines to cause another evolving variable Y if predictions of the value of Y based on Y's own past values and on the past values of X are better than predictions of Y based only on Y's own past values. The causality analysis quantifies the causal effect from the communication time series to the event time series. A high causal correlation indicates that the communication channel is effective for that user's actions in response, for example, the users refill behaviors.

In an embodiment, the causality analysis returns a p-value and the user is labeled with the numerical value p, from the p-value obtained from the causality analysis. The p-value represents a probability value, indicating how likely it is that the data could have occurred under the null hypothesis. The p-value represents the probability of obtaining results at least as extreme as the observed results of a statistical hypothesis test, assuming that the null hypothesis is correct. The system compares the p-value of the causality analysis with a threshold, (for example, 0.05) to determine a binary label for the user. For example, the binary label may of one or, indicating that the communication channel is effective (e.g., if p<0.05) or not effective (e.g., p>0.05) respectively. In an embodiment, the system performs causality analysis for all users in training set to obtain the binary label for each user.

The communication engine 260 includes the instructions for interfacing with the various communication channels. For example, if the effective communication channel is selected to be a messaging channel, the communication engine 260 invokes the right application programming interface (API) to send a message to the user. If the effective communication channel is selected to be an automatic voice bases channel, the communication engine 260 invokes the right API to construct the audio signal and send as an automatic voice message to the user.

The user prioritization module 255 receives an input set of users and ranks them in order of priority for communicating with the users. The prioritization is determined based on predicted outcome of the communications, optimal utilization of communication resources as well as the attributes of the users. For example, the attributes of certain users may indicate that there is an urgency to send them a communication within a threshold period of time. The communication module 130 selects users for communicating based on the prioritization determined by the user prioritization module 255. In an embodiment, the user prioritization module 255 module identifies eligible members and prioritizes them based on values predicted using machine learning based models described herein including (1) predicted percentage days covered (PDC), e.g., predicted end of year PDC and (2) predicted gap days for the user.

In an embodiment, the user prioritization module 255 includes submodules percentage days covered prediction module 275 and gap days prediction module 285. The percentage days covered prediction module 275 prioritizes the members based on predicted PDC for a particular time interval, for example, end of year PDC. The percentage days covered prediction module 275 classifies members into different adherence rate buckets at the end of a time interval, for example, at the end of the predicting year. The system determines user adherence rate (percentage days covered) based on the number of days a user is on the prescription from the first prescription fill date till the end of the time interval, for example, the prediction year. The percentage days covered prediction module 275 module takes user profile data, for example, the health care profile data and historical adherence rates as input. The percentage days covered prediction module 275 performs feature engineering and feature selection on all the features to make the final prediction, for example, using the PDC model. The percentage days covered prediction module 275 module works in conjunction with the gap days prediction module 285.

The gap days prediction module 285 identifies a time window, for example, a monthly time window for performing communication with the user, for example, for intervention. The gap days prediction module 285 uses gap days model to predict gaps days for the users and identifies members with predicted gaps days. The gap days prediction module 285 determines a metric gap representing gap days that describes the number of days the member is without a desired prescription in a time interval, for example, in the prediction year. The gap days prediction module 285 determines the gap days based on previous prescription end date and current prescription start date or prediction date. Along with healthcare profile data the gap days prediction module 285 takes historical refill data as input to make prediction. Prior to the prediction, the gap days prediction module 285 pre-processes all the features to check the significance between the individual feature and target variable to better improve the final prediction.

In an embodiment, the gap days model is a classification model such as a tree based model or a neural network, for example, an auto encoder that takes as input, time series data and encodes it to generate a feature vector representation of the time series data. The feature vector representation is the output of a hidden layer of the neural network processing the time series as input. The neural network further processes the feature vector representation of the time series data to reconstruct the input time series data. In an embodiment, the time series data for a user input to the neural network includes (1) event time series data for the user and (2) communication time series data for the user. The neural network encodes the input time series data to a compressed representation and then decodes or uncompresses the compressed representation to generate output that reconstructs the input time series data. The input time series data corresponds to a time interval, for example, communications or events for a user that occurred in a year. The neural network is executed to reconstruct a portion of a time series that represents the end of the time interval. Accordingly, the neural network may be used to predict the portion of the time series that occurs in future. The neural network 300 may be used to predict user events that may occur in future. For example, if a user event represents an attribute of a user indicating whether the user has medication, the neural network may be used to predict gap periods for the user when the user is without medication. The predicted gap periods are used to determine the time for sending communications to the user, for example, interventions that inform or request the user to pick up medication. The communications may be timed such that the communication is sent within a threshold time interval of a predicted gap period. Timing the communications based on predictions of gap periods for a user increase the likelihood of the user responding to the communication. In general, a user is more likely to respond if the user is contacted before a predicted gap period indicating the time period when user is expected to run out of medication. In an embodiment, the neural network is trained using historical data. Certain portions of the communication time series and/or the event time series are masked before providing them as input to the neural network for training. The neural network reconstructs the time series and determines the actual values of the time points that were masked. The predicted values are compared with the actual values of the time series before the values were masked to determine a loss value for the reconstruction by the neural network. The weights (i.e., parameters) of the machine learning based model, for example, a neural network are adjusted during the training to minimize the loss values.

The optimization module 265 maximizes the user adherence rate for the selected users and minimizes the overall communication cost for communication with the user. The optimization module 265 uses information from member prioritization and intervention recommendation blocks overlaid in optimization module. Performance of model is evaluated by test and learn process. The feedback loop enables the recommendation system to self-improve by taking most recent member behavior and learnings from test and learn process and feeding it back to system as input. This process helps system to efficiently identify the best intervention type and time at a member level by reducing member fatigue and improving overall cost. Furthermore, the optimization module 265 adjusts the system parameters based on the latest user data to ensure that any changes to user patterns are accounted for by modifying the system appropriately.

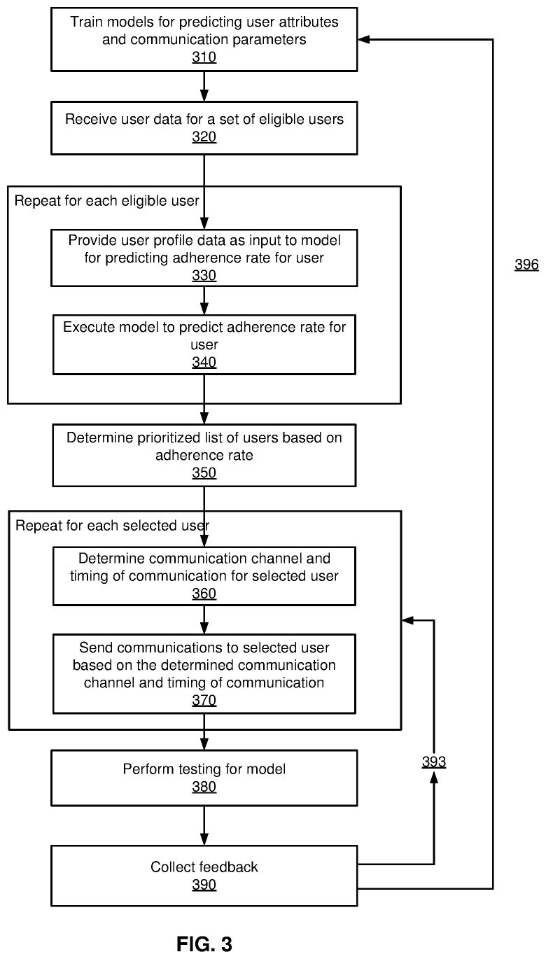

Various processes executed by the modules are described herein. FIGS. 3-5 illustrated various processes for training and executing machine learning based models for determining communicating channels for communicating with users according to various embodiments. The steps described herein for a process may be performed by modules other than those described herein. Furthermore, the steps may be performed in an order different from that shown herein, for example, certain steps may be performed in parallel.

### Overall Process

FIG. 3 shows a flowchart illustrating the process for selecting users for communicating, according to an embodiment. The steps of the process may be executed by the communication module 130 or by other modules. The following description indicates the steps being executed by the computing system 100, also referred to as the system.

The system trains 310 the various machine learning based models including machine learning based models for predicting user attributes such as adherence rate (for example, end of year percentage days covered) for a user and gap days for user, for example, next month's gap days for a user. The system also trains models for training communication parameters including machine learning based models for determining the communication channel to use for communicating with a user and the timing of the communication.

The system receives 320 user data for a set of eligible users. The system may import data from various sources, for example, systems storing user profile, systems storing health care profile for users, and so on. In an embodiment, the set of eligible users represents a subset of all users that satisfy certain criteria, for example, users having certain type of medical condition. The process is repeated for various sets of users satisfying different criteria to ensure that users with different sets of attributes are covered and users with a specific set of attributes do not get excluded.

The system repeats the steps 330 and 340 for each eligible user from the set. The system provides 330 user profile data for the eligible user as input to a machine learning based model for predicting adherence rate for a user. In an embodiment the system extracts various features from the user profile data and generates a feature vector for providing as input to the machine learning based model. The system executes 340 the machine learning based model to determine the adherence rate for the eligible user.

The total number of eligible users of the set may be large and the system may not have the resources to communicate with all the users from the set of eligible users. The system determines 350 a prioritized list of eligible users based on their adherence rates. The system predicts the adherence rate for a user using a machine learning based model, for example, the PDC model. In an embodiment, the system selects the subset of eligible users that have low adherence rate, i.e., adherence rate below a threshold value. In an embodiment, the system selects the subset of eligible users based on a weighted aggregate of factors including (1) their adherence rate and (2) a measure of urgency determined based on number of days within which a potential gap is predicated to occur. The measure of urgency is determined as a value that is inversely proportionate to the number of days within which a potential gap is predicated to occur, e.g., a user with a predicted gap that is expected to occur earlier is prioritized higher than a user with a predicted gap that is expected to occur later. The system predicts potential gap days using the gap days model. The system may prioritize a user if the user is expected to have a potential gap within a near future, i.e., within a threshold time interval.

The system repeats steps 360 and 370 for each selected user based on the prioritized list of uses. The system predicts attributes for a future time interval for the selected user using machine learning based models, for example, the system predicts gap days for the selected user within a time interval such as next month gap days for the user. The system determines 360 communication parameters for communicating with the selected user including communication channel for communicating with the user and the timing for communicating with the user based on the machine learning based models. The system sends 370 communications to the user based on the communication parameters. The system executes the optimization engine to maximize the achievable adherence rate for the selected users based on the various parameters determined by the machine learning based models.

The system may perform 380 testing of the system using techniques such as A/B testing. The A/B testing allows the system to be adjusted for optimizing various parameters. The system collects 390 feedback data to incorporate 393 feedback that requires low latency in order to optimize system resources and minimize costs as well as minimize user fatigue. The system monitors the quality of the input data as well as model outputs and may retrain 396 the machine learning based models based on the observations.

### Process for Determining Communication Channel

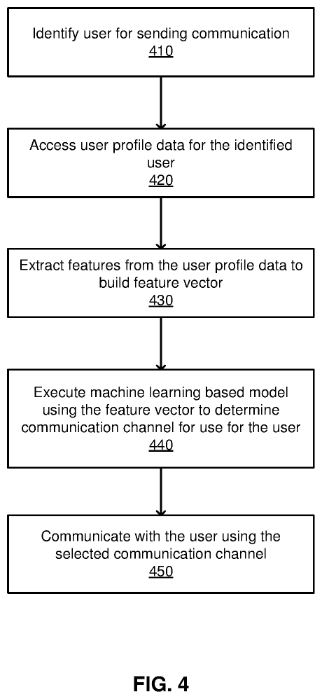

FIG. 4 shows a flowchart illustrating the process for using the machine learning based model for communicating with a user, according to an embodiment. The system identifies 410 a user for sending a communication. For example, a health care system may identify a user for communicating regarding picking up medication. The system accesses 420 user profile data for the user, for example, from the user data store 140. The system extracts 430 features from the user profile data generate a feature vector based on the user profile data for the user. The system provides the feature vector as input to the machine learning based model as input and executes 440 the machine learning based model using the feature vector to determine communication channel for use for the user. In an embodiment, the system executes multiple machine learning based models, one for each communication channel, to determine the likelihood of the user performing an expected action based on the communication using the channel. For example, for a health care system reaching out to a user regarding medication prepared for the user, the expected action is that the user picks up the medication prepared for the user. The system selects the communication channel with the highest likelihood of the user performing the expected action based on the output of the machine learning based models. The system communicates 450 with the user using the communication channel selected based on the output of the machine learning based model.

In an embodiment, the system trains the communication channel model using training data that is generated by labelling users based on causality analysis. To generate the training dataset, the system performs following steps. The system receives user profile data for users. The system accesses the user profile data for a user. The system accesses the communication time series data representing instances of communication performed with the user using the communication channel. The system accesses the event time series data representing user actions, for example, instances of expected user actions performed by the user. The system performs the causality analysis, for example, the causality analysis performed by the time series analysis module 230. The system determines a measure representing whether the event time series for the user is caused by the communication time series describing communications using the particular communication channel. The system determines label for the user for the communication channel based on the result of the causality analysis. Accordingly, the user is assigned a score indicating a high likelihood of performing the expected user action if the user receives a communication sent via the communication channel if the causality analysis Repeating the above steps for each user and for each communication channel for each user allows the system to generate labeled training data. The system uses the training data for training machine learning based model for determining communication channel to be used for communicating with a new user that is identified.

### Process for Determining Communication Timing

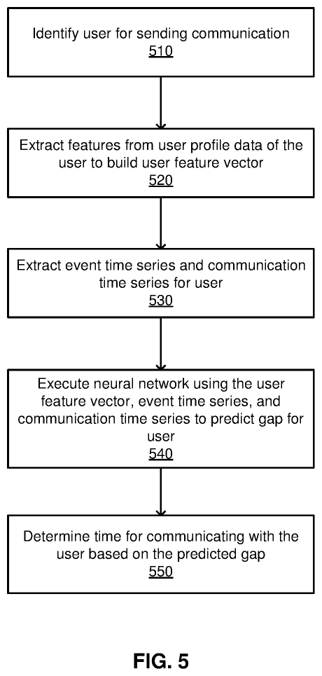

FIG. 5 shows a flowchart illustrating the process for determining timing for communicating with a user based on machine learning model, for example, a neural network representing the gap days model according to an embodiment. Once the neural network is trained, the neural network can be used for predicting events for users, for example, for determining the gap days in future for a user. The gap days are used for determining when to send communications to user, for example, for intervention.

The system identifies 510 a user for sending communication. The system extracts 520 features from the user profile data for the user to build the user feature vector. The system extracts 530 time series data including the event time series and communication time series from the user data. The system provides the user profile data and the time series data as input to the neural network and executes 540 the neural network to predict events for the user in the future, for example, gap days for the user. The system determines 550 the time for sending communications to the user based on the predicted events of the future, for example, based on the predicted gap days. The system sends the communications according to the determined time.

### Applications

The machine learning platform described herein may be used for various systems that have a user based and that need to reach out to users for various interactions. As described, healthcare providers may reach out to users to inform them of medications that they need to pick up. The techniques may be used by pharmacies for outreach of members under medical conditions (for example, diabetes) who are with medical refill gaps, thereby helping the pharmacy close the gaps. It is important for several member with specific medical conditions such as diabetes, to ensure that there are no medical refill gaps, to ensure they have adequate supply of the medication to avoid further complications to their medical conditions. Accordingly, health care provides reach out to the member to remind the member to pick up their medication. The pharmacy or any healthcare provider may use various communication channels for reaching out to members including automatic voice call, live agent call such as clinician call, in-pharmacy intervention, intervention via a third-party company, for example, drug companies, and so on. Different users respond differently to specific channels and some channels are more effective in reaching the members. The techniques allow the system to predict the optimal communication channel for reaching a particular member to increase a chance the chance member would be reached successfully and pick up the medication as a result.

The user interaction data for these domains includes dates of receiving refills, dates and types of the outreaches for each member, and so on. For health care domain, the user profile data include members health care related values, for example, probabilities of use tobacco/alcohol, diet habits, exercise habits, and so on, and pharmacy related values, for example, adherence. The user profile data may be represented as numerical values or as categorical indexes.

Other applications that may use the techniques disclosed include organizations that may reach out to different users. For example, representatives of clients or sales departments that may reach out to customers or potential leads, publishers may reach out to subscribers, and so on. Use of the techniques ensures that the organization has a higher success rate in reaching the users and are able to receive better response from the users. The rate of user response typically affects the results that the organizations aim to achieve, for example, business.

### Technological Improvements

Conventional techniques for determining the right communication channel for reaching out to users are based on rigid rule-based techniques. These techniques suffer from several drawbacks. More specifically, these are not customized to individual users. At best they may use broad categories of users and apply specific rules for each category. Still, these techniques are not optimized and personalized for individual users. In contrast, the techniques disclosed according to various embodiments are optimized and personalized to individual users. Another drawback of the rule base techniques is that they do not adapt to continuously changing data. For example, a user's behavior may change over time, but the rule based technique may continue to make the same prediction for the user since prediction is based on rigid and simplistic rules based on user characteristics that may not reflect the change in user behavior. To monitor the change in user behavior the system needs to analyze the time series data representing the user interactions, which is not performed by conventional rule-based systems.

An alternative to rule-based systems is use of machine learning based techniques for making predictions. User interaction data are stored as time series data. Machine learning models are used for making predictions based on time series data. Examples of machine learning based models that may be used for analyzing time series data include recurrent neural networks, long short-term memory (LSTM) neural networks, and so on. Techniques such as recurrent neural networks process the time series data element by element to make predictions based on the data. As a result, the neural network computation is executed several times, once for each element of the time series data. This can be a computationally slow process for long time series and complex neural network computations. LSTM is an extension of recurrent neural networks and processed the time series data in the same manner as a recurrent neural network. Embodiments improve the computational efficiency of the processing of the time series data compared to systems such as those based on recurrent neural networks that are typically used for making predictions based on time series data. This is so because the techniques use efficient techniques to process the time series data to determine correlation between time series before providing the information as input to the machine learning based model. Accordingly, the machine learning computation does not have to be executed individually for each element of the time series data, thereby improving the efficiency of computation.

Furthermore, training machine learning models for the time series data is challenging due to lack of labelled data. The information for a member may be labelled through manual inspection by determining whether the member is responsive to a particular communication channel. However, this is a tedious and error prone process. Alternatively, the labelling can be obtained by performing surveys of users. However, the rate at which users respond to such surveys is typically low, thereby providing only small amount of training data. Embodiments provide an automatic technique for labelling the training data by determining a score indicating how responsive a member is to a specific communication channel based on analysis of timeseries data. This allows automatic determination of the labels for generating training data for training machine learning models. The ability to automate the process allows for generation of more training data that results in better trained machine learning models. Furthermore, the training data generated has high accuracy compared to manual labelling that is more error prone.

### Additional Considerations

It is to be understood that the Figures and descriptions of the present invention have been simplified to illustrate elements that are relevant for a clear understanding of the present invention, while eliminating, for the purpose of clarity, many other elements found in a multi-tenant system. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Some portions of the above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for communicating with users, comprising:
receive user profile data for each of a set of eligible users;
for each eligible user from the set of eligible users:
provide user profile data for the eligible user as input to a machine learning based model; and
execute the machine learning based model to predict an adherence rate for the eligible user, the adherence rate representing the rate at which the eligible user performs a predefined action;
rank the set of eligible users based on the predicted adherence rates;
select a set of users from the set of eligible users based on the ranking; and
for each selected user from the set of selected users:
determine communication parameters for communicating with the selected user; and
send a communication to the selected user based on the determined communication parameters.

2. The computer-implemented method of claim 1, wherein a communication parameter indicates a communication channel selected from a plurality of communication channels used for communicating with users.

3. The computer-implemented method of claim 2, wherein the plurality of communication channels comprises: a communication channel for sending text messages, a communication channel for leaving voice mail, a communication channel for calling via live agent.

4. The computer-implemented method of claim 1, wherein the machine learning based model is a classification based model.

5. The computer-implemented method of claim 1, wherein the adherence rate for the eligible user represents an estimated percentage days covered for the eligible user, wherein a day is covered if the eligible user is determined to be in possession of an item.

6. The computer-implemented method of claim 1, wherein a communication parameter indicates a timing for sending a communication to the selected user.

7. The computer-implemented method of claim 6, wherein the timing for sending the communication to the selected user is determined based on a predicted gap for the user, wherein a gap indicates a time interval when the user is not in possession of an item.

8. The computer-implemented method of claim 1, wherein the user profile data includes (1) a communication time series representing communications send to the user and (2) an event time series representing user actions performed by the user.

9. A non-transitory computer readable storage medium storing instructions that when executed by a computer processor, cause the processor to perform steps comprising:
receive user profile data for each of a set of eligible users;
for each eligible user from the set of eligible users:
provide user profile data for the eligible user as input to a machine learning based model; and
execute the machine learning based model to predict an adherence rate for the eligible user, the adherence rate representing the rate at which the eligible user performs a predefined action;
rank the set of eligible users based on the predicted adherence rates;
select a set of users from the set of eligible users based on the ranking; and
for each selected user from the set of selected users:
determine communication parameters for communicating with the selected user; and
send a communication to the selected user based on the determined communication parameters.

10. The non-transitory computer readable storage medium of claim 9, wherein a communication parameter indicates a communication channel selected from a plurality of communication channels used for communicating with users.

11. The non-transitory computer readable storage medium of claim 10, wherein the plurality of communication channels comprises: a communication channel for sending text messages, a communication channel for leaving voice mail, a communication channel for calling via live agent.

12. The non-transitory computer readable storage medium of claim 9, wherein the machine learning based model is a classification based model.

13. The non-transitory computer readable storage medium of claim 9, wherein the adherence rate for the eligible user represents an estimated percentage days covered for the eligible user, wherein a day is covered if the eligible user is determined to be in possession of an item.

14. The non-transitory computer readable storage medium of claim 9, wherein a communication parameter indicates a timing for sending a communication to the selected user.

15. The non-transitory computer readable storage medium of claim 14, wherein the timing for sending the communication to the selected user is determined based on a predicted gap for the user, wherein a gap indicates a time interval when the user is not in possession of an item.

16. The non-transitory computer readable storage medium of claim 9, wherein the user profile data includes (1) a communication time series representing communications send to the user and (2) an event time series representing user actions performed by the user.

17. A computer system comprising:
one or more computer processors; and
a non-transitory computer readable storage medium storing instructions that when executed by a computer processor, cause the computer processor to perform steps comprising:
receive user profile data for each of a set of eligible users;
for each eligible user from the set of eligible users:
provide user profile data for the eligible user as input to a machine learning based model; and
execute the machine learning based model to predict an adherence rate for the eligible user, the adherence rate representing the rate at which the eligible user performs a predefined action;
rank the set of eligible users based on the predicted adherence rates;
select a set of users from the set of eligible users based on the ranking; and
for each selected user from the set of selected users:
determine communication parameters for communicating with the selected user; and
send a communication to the selected user based on the determined communication parameters.

18. The computer system of claim 17, wherein a communication parameter indicates a communication channel selected from a plurality of communication channels used for communicating with users.

19. The computer system of claim 17, wherein the adherence rate for the eligible user represents an estimated percentage days covered for the eligible user, wherein a day is covered if the eligible user is determined to be in possession of an item.

20. The computer system of claim 17, wherein a communication parameter indicates a timing for sending a communication to the selected user.
